(19) United States
(12) Patent Application Publication
(10) Pub. No.: US 2011/0268242 A1
(43) Pub. Date: Nov. 3, 2011

(54) Hydrogen and Oxygen Recombination Catalyst, Recombination Apparatus, and Nuclear Plant

(75) Inventors: Hidehiro IIZUKA, Mito (JP); Motohiro AIZAWA, Hitachi (JP); Toru KAWASAKI, Hitachi (JP); Hirofumi MATSUBARA, Hitachi (JP); Takashi NISHI, Hitachinaka (JP); Shuichi KANNO, Hitachinaka (JP); Yasuo YOSHII, Naka (JP); Yoshinori EBINA, Hitachi (JP); Takanobu SAKURAI, Hiratsuka (JP); Tsukasa TAMAI, Sagamihara (JP); Michihito ARIOKA, Yokohama (JP)

(73) Assignees: Nikki-Universal Co., Ltd., Tokyo (JP); Hitachi-GE Nuclear Energy, Ltd., Hitachi-shi (JP)

(21) Appl. No.: 13/095,547

(22) Filed: Apr. 27, 2011

(30) Foreign Application Priority Data
Apr. 28, 2010 (JP) 2010-103115

(51) Int. Cl. G21C 15/00; B01J 21/04; B01J 21/06; B01J 21/08; B01J 8/02; B01J 23/42; B01J 23/44; B01J 23/46; B01J 23/52; B01J 23/00; B01J 29/04

(52) U.S. Cl. 376/402; 502/300; 502/355; 502/350; 502/240; 502/87; 502/339; 502/325; 502/344; 502/334; 502/333; 502/332; 502/262; 502/261; 502/243; 502/74; 422/211

(57) ABSTRACT

A recombination apparatus is provided to an off-gas system of a boiling water nuclear plant. An off-gas system pipe connected to a condenser is connected to the recombination apparatus. A catalyst layer filled with a catalyst for recombining hydrogen and oxygen is disposed in the recombination apparatus. The recombination catalyst has a percentage of the number of Pt particles whose diameters are in a range from more than 1 nm to not more than 3 nm to the numbers of Pt particles whose diameters are in a range from more than 0 nm to not more than 20 nm, falling within a range from 20 to 100%. The condenser discharges gas containing an organosilicon compound (ex. D5), hydrogen, and oxygen, which is introduced to the recombination apparatus. Use of the above recombination catalyst can improve the performance of recombining hydrogen and oxygen more than conventional catalysts and the initial performance of the catalyst can be maintained for a longer period of time.

### CLAIM OF PRIORITY

The present application claims priority from Japanese Patent application serial no. 2010-103115, filed on Apr. 28, 2010, the content of which is hereby incorporated by reference into this application.

### BACKGROUND OF THE INVENTION

1. Technical Field

The present invention relates to a hydrogen and oxygen recombination catalyst, a recombination apparatus, and a nuclear plant, and more particularly to a hydrogen and oxygen recombination catalyst, recombination apparatus, and a nuclear plant suitable for an off-gas system of a boiling water nuclear plant.

2. Background Art

While global warming caused by CO₂ and the like has been a serious problem, nuclear power plants that emit no CO₂ are in growing demand as a future energy supply source all over the world every year.

A boiling water nuclear plant exists as the nuclear plant. There are two types of boiling water nuclear plants. In one type of the boiling water nuclear plant, cooling water is supplied to a core in a reactor pressure vessel by driving a recirculation pump provided to a recirculation pipe connected to a reactor pressure vessel. In another type of the boiling water nuclear plant, the cooling water is supplied by an internal pump provided to a bottom portion of the reactor pressure vessel. An impeller of the internal pump is disposed in the reactor pressure vessel. The latter type of a boiling water nuclear plant having the internal pump is called an advanced boiling water reactor plant.

In a boiling water nuclear plant, cooling water in a core disposed in the reactor pressure vessel is heated by heat generated by nuclear fission of nuclear fuel material included in a plurality of fuel assemblies loaded in the core and part of the heated cooling water turns into steam. The steam generated in the reactor pressure vessel is directly supplied to a turbine. While the boiling water nuclear plant is in operation, the cooling water in the core is decomposed by radiation of gamma rays and neutrons generated by the nuclear fission, and hydrogen and oxygen are generated. This hydrogen and oxygen are introduced to the turbine along with steam generated in the reactor, as noncondensable gas. If the hydrogen and oxygen have a gas-phase reaction, combustion may occur. Thus, the boiling water nuclear plant is provided with a recombiner in an off-gas pipe of the off-gas system, filled with a combustion catalyst for promoting the recombination of hydrogen and oxygen. In this recombiner, the hydrogen and oxygen generated by radioactive decomposition are recombined and turned into water.

Japanese Patent Laid-open No. 60 (1985)-86495 and Japanese Patent Laid-open No. 62(1987-83301 describe a recombiner provided to an off-gas system pipe connected to a condenser to recombine hydrogen and oxygen in the recombiner.

Various catalysts have been proposed as a hydrogen and oxygen recombination catalyst such as: a catalyst in which, platinum group noble metal particles are supported by an alumina layer provided on the surface of a metal support made of nickel chrome alloy or stainless steel (see Japanese Patent Laid-open No. 60 (1985)-86495); and a catalyst in which, platinum group noble metal particles are supported by a sponge-like metal base material formed to have a pore size of 0.5 to 6 mm (see Japanese Patent Laid-open No. 62 (1987)-83301). In addition, a hydrogen and oxygen recombination catalyst in which, Pd is supported by an alumina support, has been proposed (see Japanese Patent No. 2680489). Although it is not a hydrogen and oxygen recombination catalyst, a catalyst using a noble metal such as platinum, rhodium, and palladium as a catalytic metal is disclosed in Japanese Patent Laid-open No. 2008-55418. This catalyst contains catalytic metal clusters having the following size distribution: 70% of the clusters have average diameters of 0.6 nm or less, and 99% of the particles have average diameters of 1.5 nm or less.

When a recombination catalyst filled in a recombiner provided to an off-gas system pipe contains more chloride ions than a predetermined amount, the chloride ions may dissolve in a fluid condensed in the recombination catalyst during an operation shut down period of the boiling water nuclear plant, and this fluid containing the chloride ions may be discharged to the downstream side of the recombination catalyst. These chloride ions may destroy a corrosion-resistant oxide film. Consequently, stress corrosion cracking may be caused in a structural member of the plant (see Japanese Patent Laid-open No. 2005-207936).

Examples of a recombiner disposed in a reactor containment vessel are described in Japanese Patent Laid-open No. 11(1999)-94992 and Japanese Patent Laid-open No. 2000-88988.

In a low-pressure turbine installed to a condenser connected to an off-gas system pipe, linseed oil has been used as a sealing agent in a packing portion. However, recently, in order to mitigate a reduction in turbine efficiency, an increasing number of plants have been switching to a liquid packing containing an organosilicon compound that can maintain airtightness more easily than linseed oil.

Karl Arnby et al. Applied Catalysis B, Characterization of Pt/Fe-Al203 catalysts deactivated by hexamethyldisiloxane, pp. 1-7 (2004), Masahiko Matsumiya et al. Sensors and Actuators B, Poisoning of platinum thin film catalyst by hexamethyldisiloxane (HMDS) for thermoelectric hydrogen gas sensor, pp. 516-522 (2003), and Jean-Jacques Ehrhardt et al. Sensors and Actuators B, Poisoning of platinum surfaces by hexamethyldisiloxane (HMDS): Application to catalytic methane sensors, pp. 117-124 (1997) report that a slight amount of hexamethyldisiloxane (HMDS) is generated from a liquid packing even at room temperature, and the HMDS adheres on an electrode of a combustible-type hydrogen sensor and reduces the performance of the combustible-type hydrogen sensor.

### CITATION LIST

### Patent Literatures

Patent literature 1: Japanese Patent Laid-open No. 60 (1985)-86495
Patent literature 2: Japanese Patent Laid-open No. 62 (1987)-83301
Patent literature 3: Japanese Patent No. 2680489
Patent literature 4: Japanese Patent Laid-open No. 2008-55418
Patent literature 5: Japanese Patent Laid-open No. 2005-207936
Patent literature 6: Japanese Patent Laid-open No. 11(1999)-94992
Patent literature 7: Japanese Patent Laid-open No. 2000-88988

### Non-Patent Literatures

Non-patent literature 1: Karl Arnby et al. Applied Catalysis B, Characterization of Pt/Fe-Al203 catalysts deactivated by hexamethyldisiloxane, pp. 1-7 (2004)
Non-patent literature 2: Masahiko Matsumiya et al. Sensors and Actuators B, Poisoning of platinum thin film catalyst by hexamethyldisiloxane (HMDS) for thermoelectric hydrogen gas sensor, pp. 516-522 (2003)
Non-patent literature 3: Jean-Jacques Ehrhardt et al. Sensors and Actuators B, Poisoning of platinum surfaces by hexamethyldisiloxane (HMDS): Application to catalytic methane sensors, pp. 117-124 (1997)

### SUMMARY OF THE INVENTION

### Technical Problem

As described above, an increasing number of plants have been using the liquid packing, which can maintain airtightness more easily, as a sealing agent in a packing portion in a low-pressure turbine installed to a condenser connected to an off-gas system pipe. However, in light of each report by Karl Arnby et al., Masahiko Matsumiya et al., and Jean-Jacques Ehrhardt et al, it is believed that the performance of a recombination catalyst used in the boiling water nuclear plant using the liquid packing containing an organosilicon compound may be reduced by silicon adhesion.

It is an object of the present invention to provide a hydrogen and oxygen recombination catalyst, a recombination apparatus, and a nuclear plant that can improve catalytic performance even upon exposure to gas containing an organosilicon compound and allows the initial performance of the catalyst to be maintained for a longer period of time.

### Solution to Problem

A feature of the present invention for attaining the above object is a hydrogen and oxygen recombination catalyst comprising porous support and catalytic metal supported by the porous support, wherein a percentage of the number of particles of the catalytic metal whose diameters are in a range from more than 1 nm to not more than 3 nm to the number of particles of the catalytic metal whose diameters are in a range from more than 0 nm to not more than 20 nm is within a range from 20 to 100%.

In the recombination catalyst, a percentage of the number of particles of the catalytic metal whose diameters are in a range from more than 1 nm to not more than 3 nm to the number of particles of the catalytic metal whose diameters are in a range from more than 0 nm to not more than 20 nm is in a range from 20 to 100%, thus, the ratio of the number of particles of the catalytic metal whose diameters are in a range from more than 1 nm to not more than 3 nm is increased so that when the recombination catalyst is come in contact with gas containing hydrogen, oxygen, and an organosilicon compound, the catalytic performance of recombining hydrogen and oxygen in the recombination catalyst can be improved by more than that of conventional catalysts, and the initial performance of the catalyst can be maintained for a longer period of time than the conventional catalysts.

Preferably, the catalytic metal is at least one kind selected from Pt, Pd, Rh, Ru, Ir, and Au. In particular, Pt and Pd are the most preferable as the catalytic metal.

A recombination apparatus filled with the recombination catalyst having a percentage of the number of particles of the catalytic metal whose diameters are in a range from more than 1 nm to not more than 3 nm to the number of particles of the catalytic metal whose diameters are in a range from more than 0 nm to not more than 20 nm, which falls within a range from 20 to 100%, is preferably installed to an off-gas pipe connected to a condenser, or disposed in a reactor containment vessel.

### Advantageous Effect of the Invention

According to the present invention, even when the recombination catalyst is come in contact with gas containing hydrogen, oxygen, and an organosilicon compound, the catalytic performance of recombining hydrogen and oxygen in the recombination catalyst can be improved by more than that of conventional catalysts and the initial performance of the catalyst can be maintained for a longer period of time than the conventional catalysts.

### BRIEF DESCRIPTION OF THE DRAWINGS

FIG. 1 is a structural view showing an off-gas system of a boiling water nuclear plant using a recombination apparatus according to embodiment 1 which is a preferred embodiment of the present invention.

FIG. 2 is a structural view showing a recombination apparatus shown in FIG. 1.

FIG. 3 is a transmission electron micrograph showing a catalyst A filled in a catalyst layer of a recombination apparatus shown in FIG. 2.

FIG. 4 is a transmission electron micrograph showing a conventional catalyst.

FIG. 5 is an explanatory drawing showing a diameter distribution of Pt particles in catalyst used in a recombination apparatus.

FIG. 6 is a characteristic drawing showing a relationship between velocity of flow of gas in catalyst layer and indicator of residual hydrogen in the gas at outlet of the catalyst layer.

FIG. 7 is a characteristic drawing showing a change in catalytic performance of recombining hydrogen and oxygen upon exposure to gas containing an organosilicon compound when a percentage of the number of Pt particles whose diameters are in a range from more than 1 nm to not more than 3 nm is varied in catalyst.

FIG. 8 is a structural view showing a reactor containment vessel in a boiling water nuclear plant disposing a recombination apparatus according to embodiment 3 which is another embodiment of the present invention.

### DETAILED DESCRIPTION OF THE PREFERRED EMBODIMENTS

The inventors have performed a quantitative analysis of gas at an inlet of a recombiner (a recombination apparatus) in an off-gas system of a boiling water nuclear plant, and consequently, have detected a cyclic siloxane compound, which is an organosilicon compound. Thus, the inventors have done various studies through trial and error to obtain a hydrogen and oxygen recombination catalyst which can improve the catalytic performance even when the recombination catalyst is come in contact with gas containing an organosilicon compound in the recombination apparatus.

Hence, the inventors have used a porous metal oxide as support to support a noble metal such as catalytic metal and have produced a new recombination catalyst (hereinafter, referred to as the new recombination catalyst) in which a percentage of the supported noble metal whose particle diameters are in a range from more than 1 nm to not more than 3 nm to the noble metal whose particle diameters are in a range from more than 0 nm to not more than 20 nm is 20 to 100%. The inventors have newly found out that this new recombination catalyst has improved endurance to an organosilicon compound upon exposure to gas containing the organosilicon compound, improving the catalytic performance of recombining hydrogen and oxygen than conventional catalysts, and allows the initial performance of the catalyst to be maintained for a longer period of time than the conventional catalysts.

A conventional catalyst is produced by drying alumina immersed with a chloroplatinic solution, performing hydrogen reduction, cleaning with hot water for dechlorination, firing, and performing hydrogen reduction again. In contrast, the new recombination catalyst the inventors have newly found is produced by drying alumina immersed with a catalytic metal source, for example, a diammine dinitro platinum nitric acid solution, performing hydrogen reduction of a noble metal (ex. platinum) at a high temperature after the drying of the alumina, and cleaning with warm water for dechlorination.

A ceramic catalyst and a metal catalyst are available as a recombination catalyst used in a recombiner. The catalyst in which an active component is supported by a granularly or columnarly formed support made of ceramics is called a ceramic catalyst. The catalyst in which an active component and the support are on a porous sponge-like metal base material is called a metal catalyst. The new recombination catalyst can be produced as either type of ceramic or metal catalyst.

The forms of the new recombination catalyst include, for example, a porous metal oxide formed in a granular or columnar form, a porous metal oxide coated on a foam metal base material, and a porous metal oxide coated on a honeycomb base material produced from ceramic such as cordierite and metallic material such as Ni—Cr—Fe—Al, on each of which oxide, an active component is supported.

Catalytic metal supported by the porous metal oxide is an active component and is the site of reaction to allow a recombination reaction, that is, a reaction for generating H₂O from oxygen and hydrogen contained in the gas. The active component for converting H₂ and O₂ into H₂O is preferably at least one kind selected from noble metals (Pt, Pd, Rh, Ru, and Ir), which are components for dissociating and stimulating hydrogen molecules, and Au which is a component for stimulating oxygen molecules. In particular, Pt and Pd are suitable as the active component since their performance of H₂O conversion is high even at a low temperature of 155° C. that is necessary for the recombination reaction.

A content of catalytic metal (ex. noble metal) in the new recombination catalyst is preferably 1.5 to 2.5 g to 1 L of the new combination catalyst. When the content of the noble metal is less than 1.5 g, the surface exposure of the noble metal is significantly decreased due to the reduced content of the noble metal, reducing the recombination performance. A content of the noble metal more than 2.5 g is not preferable in view of economic efficiency.

A catalytic metal source in the new recombination catalyst may be either fine particles of the noble metal or a noble metal compound, but water soluble salt of the noble metal is preferable. In order for the new recombination catalyst to have a chlorine concentration of 0 to 5 ppm, the catalytic metal source preferably contains no chlorine. For example, preferable catalytic metal source is nitrate, ammonium salt or ammine complex of the noble metal. Specifically, a tetraamineplatinum oxalate solution, a tetraammineplatinum nitrate solution, a diammine dinitro platinum nitric acid solution, a hexaammineplatinum oxalate solution, palladium nitrate, diammine dinitro palladium, and a gold nanocolloid solution are preferable.

In the production process of the new recombination catalyst, the following methods can be used in reduction: heating in an atmosphere including hydrogen, or using a reaction by a reducing agent such as hydrazine in a liquid phase.

The porous metal oxide has a function as support for holding an active component (catalytic metal) in a stable, highly dispersed condition during a recombination reaction. When a specific surface of the porous metal oxide is 140 m²/g or more, the dispersibility of an active component on the porous metal oxide will be favorably high. When the specific surface is less than 140 m²/g, the dispersibility of the active component on the porous metal oxide will be unfavorably reduced. Any of γ alumina, a alumina, titania, silica, and zeolite is preferably used as the porous metal oxide.

An embodiment of the present invention reflecting the above results of studies done by the inventors will be described below.

### Embodiment 1

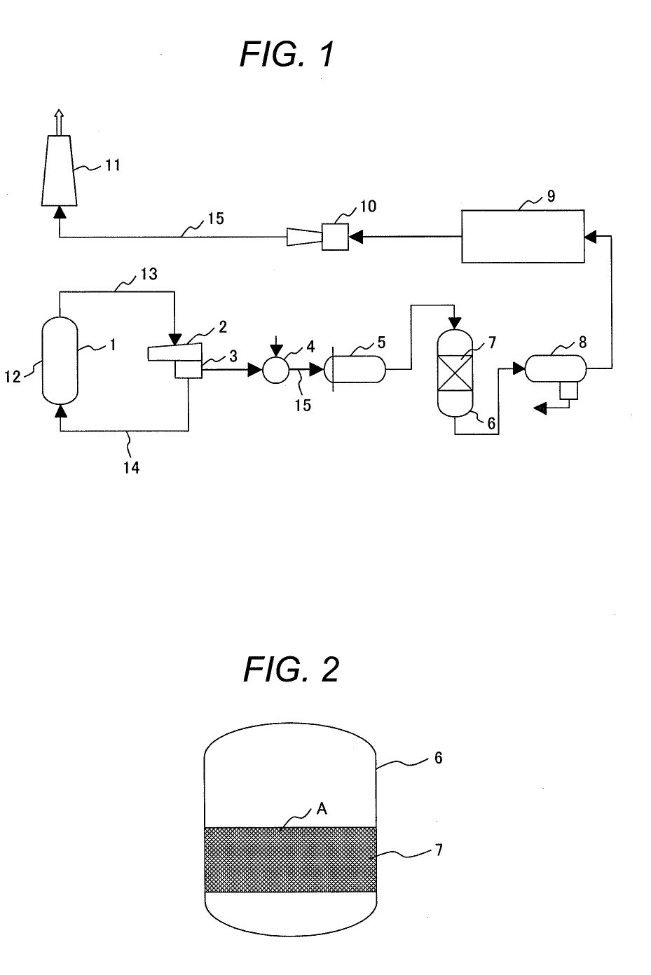

A boiling water nuclear plant to which a recombination apparatus according to embodiment 1 which is a preferred embodiment of the present invention, will be described with reference to FIG. 1. This boiling water nuclear plant is provided with a reactor 1, a high-pressure turbine (not shown), a low-pressure turbine 2, a condenser 3, an off-gas system pipe 15, and a recombination apparatus (a recombiner) 6. The reactor 1 has a reactor pressure vessel 12 and a core (not shown) disposed in the reactor pressure vessel 12. A plurality of fuel assemblies including nuclear fuel material is loaded in the core. A plurality of control rods (not shown) is provided to the reactor pressure vessel 12 to control reactor power by inserting or withdrawing these control rods into or from the core.

The high-pressure turbine (not shown) and the low-pressure turbine 2 are connected to the reactor pressure vessel 12 with a main steam pipe 13. The low-pressure turbine 2 is disposed on the downstream side of the high-pressure turbine and installed to the condenser 3. A liquid packing is used as a sealing material in a packing portion of the low-pressure turbine 2. A feed water pipe 14 connected to the condenser 3 is connected to the reactor pressure vessel 12. A feed water pump (not shown) is provided to the feed water pipe 14. A generator (not shown) is coupled to the rotation axis of the high-pressure turbine and the low-pressure turbine 2.

The off-gas system pipe 15 is connected to the condenser 3, and an air ejector 4, an exhaust gas preheater 5, the recombination apparatus 6, an exhaust gas condenser 8, a noble gas holdup apparatus 9, and an air ejector 10 are provided to the off-gas system pipe 15 in this order toward the downstream end. The off-gas system pipe 15 is connected to a main exhaust stack 11.

The recombination apparatus 6 according to the present embodiment is provided with a catalyst layer 7 filled with a catalyst A inside a container, the catalyst A is a catalyst for recombining hydrogen and oxygen.

During the operation of the boiling water nuclear plant, cooling water in the reactor pressure vessel 12 is pressurized by a recirculation pump (or an internal pump) not shown in FIG. 1, and supplied to the core. This cooling water is heated by heat generated by nuclear fission of nuclear fuel material in the fuel assemblies loaded in the core, and partially becomes steam. This steam is supplied sequentially to the high-pressure turbine and the low-pressure turbine 2 through the main steam pipe 13 and rotates the high-pressure turbine and the low-pressure turbine 2. The generator connected to these turbines also rotates and electricity is generated.

The steam exhausted from the low-pressure turbine 2 is condensed in the condenser 3 and becomes water. The water accumulated in the bottom portion of the condenser 3 is pressurized by the feed water pump as feed water, and supplied to the reactor pressure vessel 12 through the feed water pipe 14.

Gas in the condenser 3 is sucked by the air ejector 4 and discharged into the off-gas system pipe 15. Pressure in the condenser 3 is kept in a vacuum of approximately 5 kPa by the action of the air ejector 4 to improve the turbine efficiency. The cooling water in the core is decomposed into hydrogen and oxygen by radiation (neutrons and γ rays) generated by the nuclear fission. The hydrogen and the oxygen are included in the flow of the steam generated in the core and are discharged to the condenser 3 through the high-pressure turbine and the low-pressure turbine 2. The hydrogen and the oxygen discharged to the condenser 3 are also discharged to the off-gas system pipe 15 by the sucking action of the air ejector 4.

The gas containing the hydrogen and the oxygen discharged from the condenser 3 flows through the off-gas system pipe 15 and reaches the exhaust gas preheater 5. The gas is heated to a predetermined temperature by the exhaust gas preheater 5. Since the combining reaction of hydrogen and oxygen by the catalyst A in the catalyst layer 7 of the recombination apparatus 6 is promoted by higher temperatures, heating the gas by the exhaust gas preheater 5 will promote the combining reaction of hydrogen and oxygen in the recombination apparatus 6. The temperature-increased gas discharged from the exhaust gas preheater 5 is supplied to the recombination apparatus 6. The hydrogen and the oxygen contained in the gas are recombined by the function of the catalyst A filled in the catalyst layer 7 of the recombination apparatus 6 and become water. Because of this, a concentration of hydrogen contained in the gas discharged from the recombination apparatus 6 is reduced within a permissible range. The gas discharged from the recombination apparatus 6 is cooled by the exhaust gas condenser 8 provided to the off-gas system pipe 15 to remove moisture contained in the gas. Then, the gas is supplied to the noble gas holdup apparatus 9. The noble gas holdup apparatus 9 decreases the radiation of krypton and xenon contained in the gas, having a short half-life. The gas with radiation below a specified value is released from the main exhaust stack 11 to the outside environment by the action of the air ejector 10.

The low-pressure turbine 2 uses a liquid packing containing an organosilicon compound, which can provide superior airtightness as a sealing agent for the packing portion. Consequently, an organosilicon compound, for example, a volatile cyclic siloxane compound (a D-type) is released in the condenser 3 in negative pressure. While the previously-described HMDS is a chain compound containing two silicon atoms, when the number of silicon atoms is three or more, it may become a cyclic siloxane compound (hereinafter, referred to as a D-type). Linear siloxane, which is an organosilicon compound, may also be released in the condenser 3.

A volatile D-type (an organic compound containing silicone atoms) is also discharged from the condenser 3 to the off-gas system pipe 15 by the action of the air ejector 4. The D-type is to be discharged from the condenser 3 to the off-gas system pipe 15 during the startup period of the boiling water nuclear plant until the reactor power reaches 75%. Therefore, the gas discharged from the condenser 3 to the off-gas system pipe 15 during that period may contain the D-type in addition to hydrogen and oxygen.

When the gas containing the D-type is discharged from the condenser 3 to the off-gas system pipe 15, the gas containing hydrogen, oxygen and the D-type flows into the container of the recombination apparatus 6, and further into the catalyst layer 7 in the container. The catalyst A filled in the catalyst layer 7 can promote the combining reaction of hydrogen and oxygen even when it is come in contact with the gas containing the D-type, and a hydrogen concentration at the outlet of the recombination apparatus 6 can be reduced to a permissible value or less (for example, 4% or less in dry gas equivalent).

The catalyst A, which is a catalyst for recombining hydrogen and oxygen, used in the recombination apparatus 6 according to the present embodiment, will be described. The catalyst A is an example of the above-mentioned new recombination catalyst.

The catalyst A was produced according to the following production method. That is, alumina was coated on the surface of a sponge-like metal base material made of Ni—Cr alloy; this alumina was immersed with a noble metal source, for example, a diammine dinitro platinum nitric acid solution, to saturate the alumina with the diammine dinitro platinum nitric acid solution; then, the alumina saturated with the diammine dinitro platinum nitric acid solution was dried. Further after that, hydrogen reduction was performed for platinum supported by the alumina in an atmosphere at 500° C., and after warm water cleaning, the catalyst A was obtained. The sponge-like metal base material has numerous holes; the opening size of each of the holes is 2 to 3 mm. The metal base material is 25 mm in diameter and 11 mm in thickness. The Pt content in a 1 L (liter) of the catalyst A produced is 2 g in metal equivalent.

In order to compare the performance of the catalyst A, catalysts B and C were each produced as a comparative example. The production methods of the catalysts B and C will be described below.

First, the production method of the catalyst B will be described. Alumina was coated on surface of a sponge-like metal base material made of Ni—Cr alloy and this alumina was immersed with a chloroplatinic solution to saturate the alumina with the chloroplatinic solution. Then, the alumina saturated with the chloroplatinic solution was dried; reduction treatment was performed to the dried alumina; and the reduced alumina was cleaned with hot water for dechlorination. The dechlorinated alumina was fired at 400° C., and then, hydrogen reduction was performed again at 500° C. and the catalyst B was produced. The sponge-like metal base material has numerous holes; the opening size of each of the holes is 2 to 3 mm. The metal base material of the catalyst B is 25 mm in diameter and 11 mm in thickness in the same manner as the metal base material of the catalyst A. The Pt content in a 1 L of the catalyst B produced is 2 g in metal equivalent.

The production method of the catalyst C will be described below. Alumina was coated on surface of a sponge-like metal base material made of Ni—Cr alloy; this alumina was immersed with a chloroplatinic solution to saturate the alumina with the chloroplatinic solution. The alumina saturated with the chloroplatinic solution was dried; reduction treatment was performed to the dried alumina; and the reduced alumina was cleaned with hot water for dechlorination. The dechlorinated alumina was fired at 400° C., and then, hydrogen reduction was performed again at 350° C. and the catalyst C was produced. The sponge-like metal base material has numerous holes; the opening size of each of the holes is 2 to 3 mm. The metal base material of the catalyst C is 25 mm in diameter and 11 mm in thickness in the same manner as the metal base material of the catalyst A. The Pt content in a 1 L of the catalyst C produced is 2 g in metal equivalent.

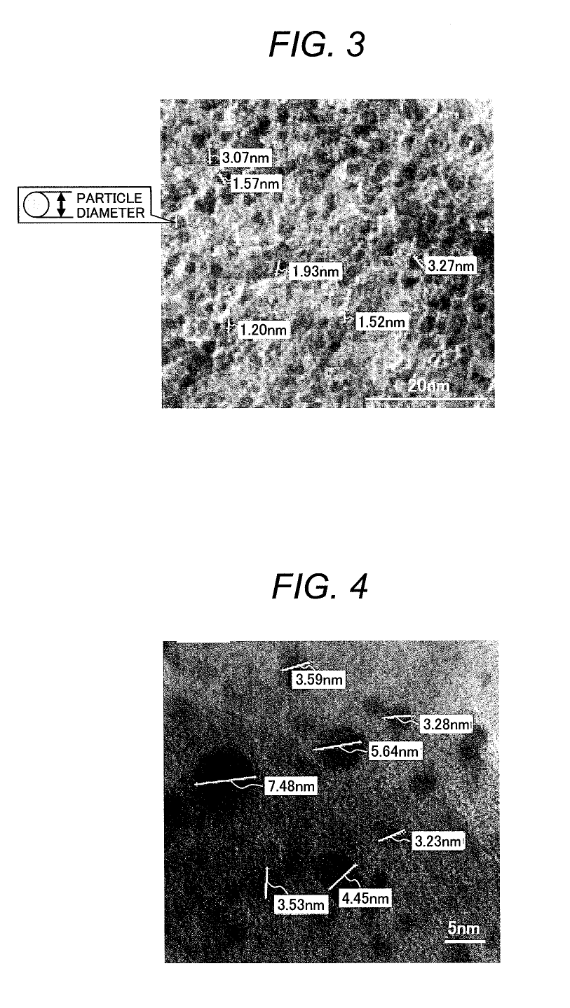

The inventors have taken each of the catalysts A, B, and C produced, and observed Pt particles in the catalyst layer portion excluding foam metal (support and an active component) under a transmission electron microscope. An example of the transmission electron micrograph of the catalyst A is shown in FIG. 3, and an example of the transmission electron micrograph of the catalyst B is shown in FIG. 4. The diameter of Pt particles supported on the surface of the sponge-like metal base material, which is the support, is the maximum diameter of each particle observed under the transmission electron microscope. Based on each transmission electron micrograph in FIGS. 3 and 4, it is clear that the catalyst A is dispersed with smaller Pt particles than the catalyst B.

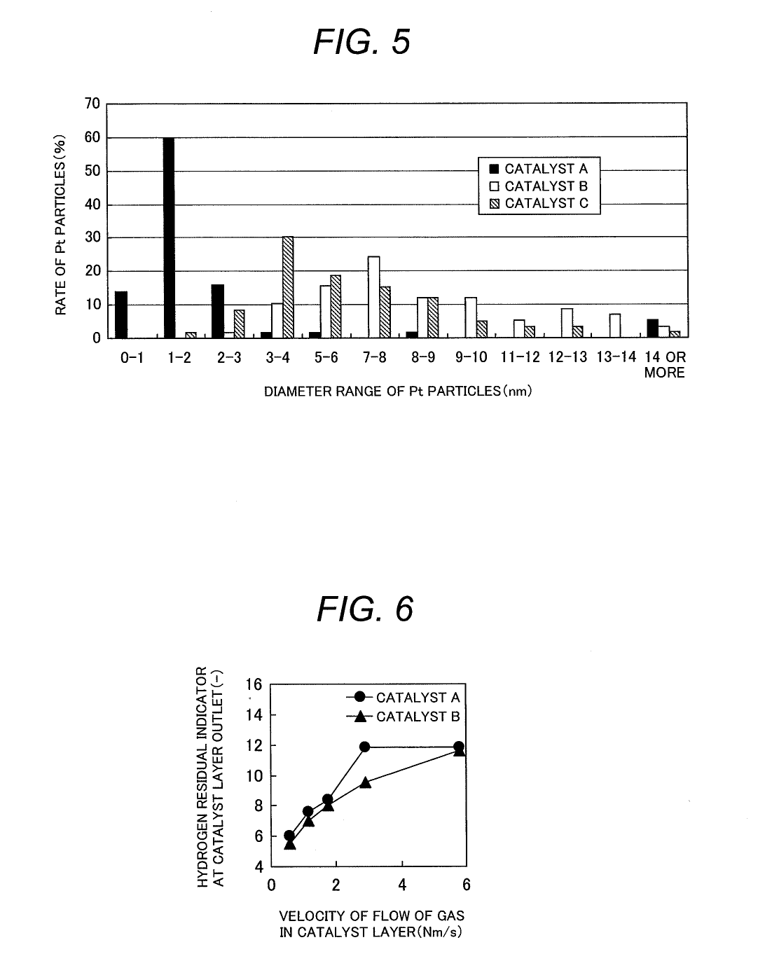

Using the transmission electron micrographs of the catalysts A, B and C, the inventors have counted the Pt particles supported on the surface of the metal base material, having diameters in a range from more than 0 nm to not more than 20 nm, for each catalyst. The particle counts were organized according to the diameter of the Pt particle, and distribution of the particle diameter of Pt particles was obtained for each catalyst. The particle diameter distribution of the Pt particles for each of the catalysts A, B, and C is shown in FIG. 5. The horizontal axis in FIG. 5 shows a range of the diameters of Pt particles. In the horizontal axis, for example, 1-2 means that these Pt particles have a diameter of more than 1 nm but not more than 2 nm, and 7-8 means that these Pt particles have a diameter of more than 7 nm but not more than 8 nm.

For the catalyst A, the Pt particle count peaks at a range of diameters from more than 1 nm to not more than 2 nm, and a percentage of the number of Pt particles whose diameters are in a range from more than 1 nm to not more than 3 nm to the number of Pt particles whose diameters are in a range from more than 0 nm to not more than 20 nm is approximately 76%.

For the catalyst B, the Pt particle count peaks at a range of diameters from more than 7 nm to not more than 8 nm, and a percentage of the number of Pt particles whose diameters are in a range from more than 1 nm to not more than 3 nm to the number of Pt particles whose diameters are in a range from more than 0 nm to not more than 20 nm is 2%.

For the catalyst C, the Pt particle count peaks at a range of diameters from more than 3 nm to not more than 4 nm, and a percentage of the number of Pt particles whose diameters are in a range from more than 1 nm to not more than 3 nm to the number of Pt particles whose diameters are in a range from more than 0 nm to not more than 20 nm is 10%.

In the catalyst A, finer Pt particles, especially those Pt particles whose diameters are in a range from more than 1 nm to not more than 3 nm, are formed more than the catalysts B and C.

The inventors have checked a specific surface of the catalyst layer portion [a support and an active component (catalyst metal) portion excluding foam metal] of each of the catalysts A, B, and C using a BET method based on nitrogen adsorption at the temperature of liquid nitrogen. The results showed that a specific surface of the catalyst A is 140 to 180 m²/g, a specific surface of the catalyst B is 80 to 120 m²/g, and a specific surface of the catalyst C is 20 to 60 m²/g. According to these results, it is clear that a catalyst having a larger specific surface can be obtained by the production method of the catalyst A.

The production method of the catalyst A allows obtaining a catalyst having the specific surface of 140 m²/g or more in the catalyst layer portion, improves the dispersibility of Pt particles in the obtained catalyst, and makes a percentage of the number of Pt particles whose diameters are in a range from more than 1 nm to not more than 3 nm to the number of Pt particles whose diameters are in a range from more than 0 nm to not more than 20 nm extremely high. In contrast, in each production method of the catalysts B and C, the specific surface is smaller than 140 m²/g, reducing the dispersibility of Pt particles, and a percentage of the number of Pt particles whose diameters are in a range from more than 1 nm to not more than 3 nm to the number of Pt particles whose diameters are in a range from more than 0 nm to not more than 20 nm is significantly reduced.

The inventors have checked a concentration of chlorine contained in the catalyst A. After immersing the catalyst A in warm water at approximately 100° C., a chlorine ion concentration in the warm water was measured using an ion chromatography method. As a result of the measurement, the concentration of chlorine contained in the catalyst A was not more than 5 ppm. When a concentration of chlorine contained in the recombination catalyst is more than 5 ppm, chloride contained in the recombination catalyst may dissolve in the water generated when the temperature drops in the recombination apparatus filled with the recombination catalyst, ex., during the shutdown of the boiling water nuclear plant. If a structural member of the boiling water nuclear plant is come in contact with this water containing chlorine ions, it increases the chance that the chloride ions will destroy a corrosion-resistant oxide film formed on the surface of the structural member or will create a stress corrosion crack on the structural member. Thus, it is preferred that a concentration of chlorine contained in the recombination catalyst be not more than 5 ppm.

Furthermore, the inventors have checked the performance of recombining hydrogen and oxygen (catalytic performance) for the catalysts A and B. Two quartz-made reaction tubes each having an inner diameter of 28 mm were prepared and separately filled with five catalysts A and five catalysts B. The quartz reaction tube filled with the catalysts A is called a quartz reaction tube A, and the quartz reaction tube filled with the catalysts B is called a quartz reaction tube B for descriptive purposes. Test condition for checking the recombination performance is as follows. The reaction gas supplied to each of the quartz reaction tubes A and B contains 1.17% hydrogen, 2.22% oxygen, 0.21% nitrogen, and 96.40% steam.

The reaction gas was supplied into each of the quartz reaction tubes A and B at velocity of flow of 0.58 to 5.8 Nm/s at 0° C. and 1 atmospheric pressure equivalent. The inlet temperature of the catalyst layer in the quartz reaction tubes A and B was 155° C. The hydrogen and the oxygen contained in the reaction gas supplied into the quartz reaction tube A were recombined by the action of the catalysts A, and the reaction gas with a reduced content of hydrogen and oxygen was discharged from the quartz reaction tube A. The hydrogen and the oxygen contained in the reaction gas supplied into the quartz reaction tube B were recombined by the action of the catalysts B, and the reaction gas with a reduced content of hydrogen and oxygen was discharged from the quartz reaction tube B. Moisture was removed from each reaction gas discharged from the quartz reaction tubes A and B. A hydrogen concentration of each reaction gas in dry base after the moisture was removed (practically, a hydrogen concentration at an outlet of the catalyst layer) was measured using a gas chromatography method.

The measurement results of hydrogen concentration are shown in FIG. 6. Hydrogen residual indicators of the reaction gas shown in FIG. 6 were obtained by equation (1). The positively larger the hydrogen residual indicator is, the lower the unreacted hydrogen concentration, that is, the catalytic performance of the recombination catalyst is higher.

Hydrogen residual indicator=−Ln (a hydrogen concentration at an outlet of the catalyst layer/a hydrogen concentration at an inlet of the catalyst layer) (1)

The hydrogen residual indicators of the catalyst A are better than the hydrogen residual indicators of the catalyst B in a range of velocity of flow of gas from 0.58 to 5.8 Nm/s (see FIG. 6). Thus, it is clear that the catalyst A having a significantly larger percentage of the number of Pt particles whose diameters are in a range from more than 1 nm to not more than 3 nm to the number of Pt particles whose diameters are in a range from more than 0 nm to not more than 20 nm is better than the catalyst B in the performance of recombining hydrogen and oxygen. In particular, the recombination performance of the catalyst A is significantly improved compared to the catalyst B at 3.0 Nm/s, which is a normal gas line velocity in the recombination apparatus 6 in the boiling water nuclear plant. In addition, the catalyst A having a larger percentage of the number of Pt particles whose diameters are in a range from more than 1 nm to not more than 3 nm than the catalyst C's has a better performance of recombining hydrogen and oxygen than the catalyst C.

Next, the inventors have checked the endurance to an organosilicon compound for each of the catalysts A, B and C. To check the endurance to an organosilicon compound, the inventors have prepared two kinds of catalysts A each having a different percentage of the number of Pt particles whose diameters are in a range from more than 1 nm to not more than 3 nm to the number of Pt particles whose diameters are in a range from more than 0 nm to not more than 20 nm. That is, the percentages of the number of Pt particles whose diameters are in a range from more than 1 nm to not more than 3 nm to the number of Pt particles whose diameters are in a range from more than 0 nm to not more than 20 nm of these catalysts A are 41% and 76% respectively. The percentage of the number of Pt particles whose diameters are in a range from more than 1 nm to not more than 3 nm can be varied by changing the temperature of hydrogen reduction of noble metal supported by alumina in the above-mentioned production method of the catalyst A. When the temperature of hydrogen reduction is made higher than the temperature of hydrogen reduction in the above-mentioned production method of the catalyst A, that is, higher than 500° C., the percentage of the number of Pt particles whose diameters are in a range from more than 1 nm to not more than 3 nm will be decreased, and when the temperature is reduced lower than 500° C., the percentage of the number of Pt particles whose diameters are in a range from more than 1 nm to not more than 3 nm will be increased.

As described above, the percentage of the number of Pt particles whose diameters are in a range from more than 1 nm to not more than 3 nm can be varied not only by changing the temperature of hydrogen reduction but also by applying a method using a platinum nanocolloid solution. In this case of using the platinum nanocolloid solution also, the temperature of hydrogen reduction can be controlled after Pt is supported by alumina to control the thermal aggregation of Pt nanoparticles. Consequently, the particle diameter of Pt particles can be appropriately controlled.

The two kinds of catalysts A each having a different percentage of the number of Pt particles whose diameters are in a range from more than 1 nm to not more than 3 nm, the catalyst B, and the catalyst C were filled into separate quartz reaction tubes each having an inner diameter of 28 mm, five per kind in each tube, and endurance to an organosilicon compound was tested. Regarding the quartz reaction tubes used in this test, the quartz reaction tube filled with a catalyst A having a percentage of the number of Pt particles whose diameters are in a range from more than 1 nm to not more than 3 nm of 41% is called a quartz reaction tube Al, the quartz reaction tube filled with a catalyst A having a percentage of the number of Pt particles whose diameters are in a range from more than 1 nm to not more than 3 nm of 76% is called a quartz reaction tube A2, the quartz reaction tube filled with the catalyst B is called a quartz reaction tube B1, and the quartz reaction tube filled with the catalyst C is called a quartz reaction tube C1 for descriptive purposes.

The test condition to check the endurance to an organosilicon compound is shown below. In this test, decamethylcyclopentasiloxane (hereinafter, referred to as D5) was used as a representative example of the organosilicon compound. The reaction gas supplied to each of the quartz reaction tubes A1, A2, B1, and C1 filled with corresponding catalysts contains 0.57% hydrogen, 0.30% oxygen, 0.22% nitrogen, and 98.91% steam. D5 was supplied to this reaction gas at 0.48 ml/h. A velocity of flow of the reaction gas including D5 in each quartz reaction tube was 3 Nm/s at 0° C. and 1 atmospheric pressure equivalent, and the inlet temperature of the catalyst layer in each quartz reaction tube was 155° C. A hydrogen concentration of each reaction gas (practically, a hydrogen concentration at the outlet of the catalyst layer) in dry base after moisture was removed from each reaction gas discharged from each quartz reaction tube was measured using a gas chromatography method. The test to check the endurance to an organosilicon compound by supplying D5 at 0.48 ml/h is an acceleration test to check the effect of D5 on the catalyst.

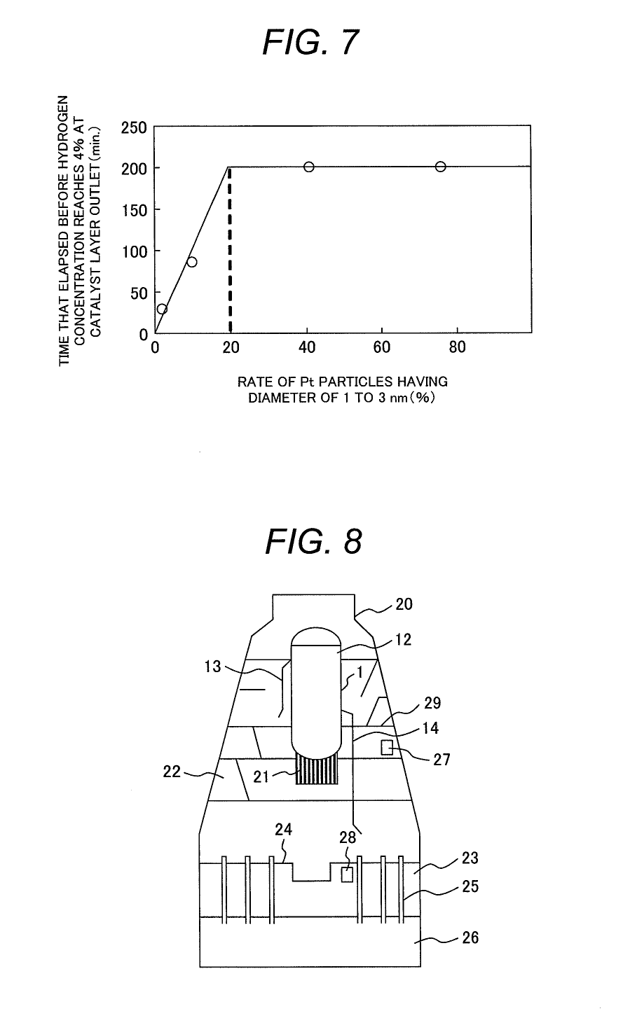

Using the hydrogen concentrations of the reaction gas discharged from each of the quartz reaction tubes A1, A2, B1, and C1, measured by the gas chromatography method, the inventors have checked the time needed for each reaction gas to reach a hydrogen concentration of 4%. The results are shown in FIG. 7. The horizontal axis in FIG. 7 is a percentage of the number of Pt particles whose diameters are in a range from more than 1 nm to not more than 3 nm to the number of Pt particles whose diameters are in a range from more than 0 nm to not more than 20 nm. According to the catalyst A used in the present embodiment, when the percentage of the number of Pt particles whose diameters are in a range from more than 1 nm to not more than 3 nm to the number of Pt particles whose diameters are in a range from more than 0 nm to not more than 20 nm is 20 to 100%, the endurance to an organosilicon compound is improved. Consequently, the catalytic performance of recombining hydrogen and oxygen in the recombination catalyst can be improved more than conventional catalysts and the initial performance of the catalyst can be maintained for a longer period of time than the conventional catalysts.

A reason that the endurance to an organosilicon compound is improved when the percentage of the number of Pt particles whose diameters are in a range from more than 1 nm to not more than 3 nm to the number of Pt particles whose diameters are in a range from more than 0 nm to not more than 20 nm is 20 to 100%, is assumed to be as follows. A decrease in the diameters of Pt particles supported by alumina increases the dispersibility of Pt and increases a percentage of surface exposure of Pt. It is believed that siloxane, for example, D5, accumulates on Pt and the support, decreases the percentage of the surface exposure of Pt gradually, and reduces the recombination performance of the catalyst. It is assumed, however, that when the percentage of the number of Pt particles whose diameters are in a range from more than 1 nm to not more than 3 nm is 20% or more in the recombination catalyst, the percentage of the surface exposure of Pt in the recombination catalyst is significantly increased, and as a result, a reduction in recombination performance is mitigated.

Since the catalyst A according to the present embodiment has a percentage of the number of Pt particles whose diameters are in a range from more than 1 nm to not more than 3 nm to the number of Pt particles whose diameters are in a range from more than 0 nm to not more than 20 nm of 76%, which is in a range of 20 to 100%, the endurance of the catalyst A to an organosilicon compound is improved. Thus, even when the recombination catalyst is come in contact with gas containing hydrogen, oxygen, and an organosilicon compound, the performance of recombining hydrogen and oxygen in the catalyst A can be improved by more than that of conventional catalysts, and the initial performance of the catalyst can be maintained for a longer period of time than the conventional catalysts. Even when the recombination apparatus 6 filled with such catalyst A can be installed to the off-gas system pipe 15 where gas containing an organosilicon compound flows through, the performance of recombining hydrogen and oxygen contained in the gas containing an organosilicon compound in the recombination apparatus 6 can be improved by more than that of the conventional recombination apparatus filled with the conventional catalyst, and the initial performance of the catalyst can be maintained for a longer period of time than the conventional catalysts.

### Embodiment 2

A boiling water nuclear plant using a recombination apparatus according to embodiment 2 which is another embodiment of the present invention, will be described below. The recombination apparatus according to the present embodiment is also provided to the off-gas system pipe 15 in the boiling water nuclear plant shown in FIG. 1 in the same manner as the recombination apparatus 6 according to embodiment 1. The recombination apparatus according to the present embodiment has a constitution in which, the catalyst A in the recombination apparatus 6 according to embodiment 1 is replaced with the following catalyst. The other structures of the recombination apparatus according to the present embodiment are the same as the recombination apparatus 6 according to embodiment 1. The catalyst used in the recombination apparatus according to the present embodiment is a ceramic catalyst, which is different from the catalyst A, that is, a metal catalyst.

This ceramic catalyst is produced as follows. They alumina particles, which are the support, are immersed with a noble metal source, for example, a diammine dinitro platinum nitric acid solution, and the γ alumina particles are penetrated with the diammine dinitro platinum nitric acid solution. Then, the γ alumina particles penetrated with the diammine dinitro platinum nitric acid solution are dried at 100 to 120° C. Hydrogen reduction is performed for platinum supported by the dried γ alumina in an atmosphere at 500° C., and after warm water cleaning for dechlorination, the catalyst used in the recombination apparatus according to the present invention, that is, the catalyst in which, Pt is supported by γ alumina particles is obtained. The catalyst in which, Pt is supported by γ alumina particles, used in the recombination apparatus according to the present embodiment, also has a percentage of the number of Pt particles whose diameters are in a range from more than 1 nm to not more than 3 nm to the number of Pt particles whose diameters are in a range from more than 0 nm to not more than 20 nm of 76%, which is in a range of 20 to 100%.

The present embodiment can obtain each effect attained in embodiment 1.

### Embodiment 3

A recombination apparatus which is another embodiment of the present invention is installed in a reactor containment vessel of a boiling water nuclear plant. The recombination apparatus according to the present embodiment is disposed in the reactor containment vessel in the same manner as in Japanese Patent Laid-open No. 2000-88988, and has a plurality of cartridges filled with a catalyst. The catalyst filled in these cartridges is the catalyst A used in embodiment 1.

Recombination apparatuses 27 and 28 according to the present embodiment are, as shown in FIG. 8, disposed in a reactor containment vessel 20. The recombination devices 27 and 28 each have a plurality of cartridges filled with the catalyst A.

The structure of the reactor containment vessel 20 will be described with reference to FIG. 8. The reactor pressure vessel 12 constituting the reactor 1 of a boiling water nuclear plant is disposed to a dry well 22 in the reactor containment vessel 20. The main steam pipe 13 and the feed water pipe 14 are connected to the reactor pressure vessel 12. A plurality of control rod drive mechanism housings 21 for storing control rod driving mechanism (not shown) is provided to a bottom portion of the reactor pressure vessel 12. A separation floor 29 is installed in the dry well 22.

The inside of the reactor containment vessel 20 is divided into the dry well 22 and a pressure suppression chamber 23 by a diaphragm floor 24. A pressure suppression pool 26 filled with pool water is formed in the pressure suppression chamber 23. A plurality of vent pipes 25 are attached to the diaphragm floor 24, one end of the vent pipe 25 is opened to the dry well 22 and another end of the vent pipe 25 is immersed into the pool water in the pressure suppression pool 26.

The recombination apparatus 27 is disposed in the dry well 22, and the recombination apparatus 28 is disposed in the space formed above a water surface of the pool water in the pressure suppression chamber 23. The recombination apparatuses 27 and 28 are preferably disposed to the location where a fluid containing hydrogen flows through or remains in the reactor containment vessel 20.

Hydrogen is found in the reactor containment vessel 20, that is, in the dry well 22 and in the space formed above the water surface of the pool water in the pressure suppression chamber 23, when a loss-of-coolant accident occurs due to breakage in the main steam pipe 13, etc. In the loss-of-coolant accident, steam that blows out of the breakage in the main steam pipe 13, etc., contains hydrogen and oxygen. This hydrogen and oxygen are recombined into water by the catalyst A in the recombination apparatuses 27 and 28, and a hydrogen concentration in the dry well 22 and the space above the water surface of the pool water in the pressure suppression chamber 23 is reduced.

There is a chance that an organosilicon compound is discharged into the dry well 22 and the space formed above the water surface of the pool water in the pressure suppression chamber 23. The recombination apparatuses 27 and 28 using the catalyst A, disposed in the reactor containment vessel 20 can also obtain each effect generated by the recombination apparatus 6 according to embodiment 1.

The catalyst used in embodiment 2 may be used in place of the catalyst A as the catalyst filled in each of the recombination apparatuses 27 and 28.

### REFERENCE SIGNS LIST

1: reactor, 2: low-pressure turbine, 3: condenser, 4, 19: air ejector, 6, 27, 28: recombination apparatus, 7: catalyst layer, 12: reactor pressure vessel, 13: main steam pipe, 20: reactor containment vessel, 22: dry well, 23: pressure suppression chamber, 24: diaphragm floor.

What is claimed is:

1. A hydrogen and oxygen recombination catalyst comprising:
a porous support; and
catalytic metal supported by the porous support,
wherein a percentage of number of particles of the catalytic metal whose diameters are in a range from more than 1 nm to not more than 3 nm to the number of particles of the catalytic metal whose diameters are in a range from more than 0 nm to not more than 20 nm is in a range from 20 to 100%.

2. The hydrogen and oxygen recombination catalyst according to claim 1,
wherein the porous support is a porous metal oxide.

3. The hydrogen and oxygen recombination catalyst according to claim 2,
wherein the porous metal oxide is one of γ alumina, α alumina, titania, silica, and zeolite.

4. The hydrogen and oxygen recombination catalyst according to claim 1,
wherein the catalytic metal is at least one kind selected from Pt, Pd, Rh, Ru, Ir, and Au.

5. The hydrogen and oxygen recombination catalyst according to claim 2,
wherein the catalytic metal is at least one kind selected from Pt, Pd, Rh, Ru, Ir, and Au.

6. The hydrogen and oxygen recombination catalyst according to claim 3,
wherein the catalytic metal is at least one kind selected from Pt, Pd, Rh, Ru, Ir, and Au.

7. A recombination apparatus comprising:
a casing; and a catalyst layer provided in the casing, filled with recombination catalysts,
wherein the recombination catalyst includes a porous support, and catalytic metal supported by the porous support, and
wherein a percentage of number of particles of the catalytic metal whose diameters are in a range from more than 1 nm to not more than 3 nm to the number of particles of the catalytic metal whose diameters are in a range from more than 0 nm to not more than 20 nm is in a range from 20 to 100%.

8. The recombination apparatus according to claim 7,
wherein the porous support is a porous metal oxide.

9. The recombination apparatus according to claim 8,
wherein the porous metal oxide is one of y alumina, a alumina, titania, silica, and zeolite.

10. The recombination apparatus according to claim 7,
wherein the catalytic metal is at least one kind selected from Pt, Pd, Rh, Ru, Ir, and Au.

11. The recombination apparatus according to claim 8,
wherein the catalytic metal is at least one kind selected from Pt, Pd, Rh, Ru, Ir, and Au.

12. The recombination apparatus according to claim 9,
wherein the catalytic metal is at least one kind selected from Pt, Pd, Rh, Ru, Ir, and Au.

13. A nuclear plant comprising:
a condenser condensing steam discharged from a reactor pressure vessel;
an off-gas system pipe connected to the condenser and introducing gas discharged from the condenser; and
a recombination apparatus provided to the off-gas system pipe,
wherein the recombination apparatus has a casing; and a catalyst layer provided in the casing, filled with recombination catalysts,
wherein the recombination catalyst includes a porous support, and catalytic metal supported by the porous support, and
wherein a percentage of number of particles of the catalytic metal whose diameters are in a range from more than 1 nm to not more than 3 nm to the number of particles of the catalytic metal whose diameters are in a range from more than 0 nm to not more than 20 nm is in a range from 20 to 100%.

14. The nuclear plant according to claim 13,
wherein the porous support is a porous metal oxide.

15. The nuclear plant according to claim 14,
wherein the porous metal oxide is one of γ alumina, α alumina, titania, silica, and zeolite.

16. The nuclear plant according to claim 13,
wherein the catalytic metal is at least one kind selected from Pt, Pd, Rh, Ru, Ir, and Au.

17. A nuclear plant comprising:
a reactor pressure vessel; a reactor containment vessel surrounding the reactor pressure vessel; and a recombination apparatus disposed in the reactor containment vessel,
wherein the recombination catalyst includes a porous support, and catalytic metal supported by the porous support, and
wherein a percentage of number of particles of the catalytic metal whose diameters are in a range from more than 1 nm to not more than 3 nm to the number of particles of the catalytic metal whose diameters are in a range from more than 0 nm to not more than 20 nm is in a range from 20 to 100%.

18. The nuclear plant according to claim 17,
wherein the porous support is a porous metal oxide.

19. The nuclear plant according to claim 18,
wherein the porous metal oxide is one of γ alumina, a alumina, titania, silica, and zeolite.

20. The nuclear plant according to claim 17,
wherein the catalytic metal is at least one kind selected from Pt, Pd, Rh, Ru, Ir, and Au.
